(19) United States
(12) Patent Application Publication
(10) Pub. No.: US 2010/0106804 A1
(43) Pub. Date: Apr. 29, 2010

(54) SYSTEM AND METHOD FOR PROCESSING LOCAL FILES USING REMOTE APPLICATIONS

(75) Inventors: Le He, Beijing (CN); Xing Jin, Beijing (CN); Qingbo Wang, Beijing (CN); Yang Zhao, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/606,389

(22) Filed: Oct. 27, 2009

(30) Foreign Application Priority Data
Oct. 28, 2008 (CN) 200810169787.9

(51) Int. Cl. G06F 15/16; G06F 17/30

(52) U.S. Cl. 709/219; 707/705

(57) ABSTRACT

A system and method for processing local files using remote applications. The system includes an apparatus for processing local files using remote applications, including: an operation capturing unit configured to capture user operations on local files, and send operation requests to a server; a file sharing unit configured to share said local files in a network and send a sharing path to the server; and a remote desktop unit configured to connect to the target processing appliance using remote desktop. The system also includes a remote application management server, including: file type matching unit configured to match the local file to a particular remote application; a processing appliance choosing unit configured to determine a target processing appliance; and an instruction file generating unit configured to generate an instruction file for the above processing appliances. The methods correspond to the above apparatus and server.

### CROSS REFERENCE TO RELATED APPLICATION

This application claims priority under 35 U.S.C. §119 from Chinese Patent Application No. 200810169787.9 filed Oct. 28, 2008, the entire contents of which are incorporated by reference herein.

### BACKGROUND OF THE INVENTION

1. Field of the Invention

This invention relates to virtual appliances and remote applications. More particularly, the present invention relates to a system and method for processing local files remotely using virtual appliances and remote applications.

2. Description of the Related Art

In the information technology (IT) field, virtualization is bringing real and fresh experiences for people. In the long term, the usage of virtualization will bring ultimate transformation for IT operation. More specifically, virtualization can help to simplify the reconfiguration of hardware appliances. It is possible to transfer a virtual appliance from one hardware platform to another hardware platform without disturbing its application environment because virtualization isolates virtual appliances (also referred to as virtual machines) from the details of the servers on which they are hosted. Then it is possible to provide a way of consolidating isolated individual applications in small servers into a large hardware platform by using virtualization to facilitate centralized management of these applications and more effectively use the system resources. Thereby, it reduces the owners' management cost on these applications and improves the system's reliability and flexibility.

On the other hand, current desktop applications are installed in the operating system on the client side with their setting and configuration integrated in the operating system. For non-professional users, the installing, configuring and removing process of these applications may cause many troubles and inconvenience in this mode. Sometimes, the configuration of one application may even overwrite the setting or configuration of other applications or the operating system, which causes system malfunctions or crashing.

Compared to the current desktop applications on the client side, the web-based applications are more convenient to distribute, access, and manage. However, for current web-based applications, the application server suppliers usually need to develop a web based version again for an application. For example, the supplier of a web Office application needs to develop a new version for web use which is different from the local desktop Office version. For users of these web-based applications, they have to upload the file to be processed to the application server when using these applications to process local files and download the processed file from the server to the local file after processing. During this process, the risk on system security and user's privacy prevent the approach from the wide adoption.

Based on the above solutions, the virtualization of the applications or the virtual application makes each application have its own configurations and execute in an independent environment. This enables virtual applications to be provisioned dynamically from the server side and ensures other settings of the host operating system unaltered. However, this approach still needs to download the virtualized application to the local machine on the client side, which is a time-consuming process and even not applicable for small clients.

In view of the above-mentioned problems, it is a desired approach to consolidate various desktop applications on the server side making use of characteristic of virtualization and provide them to the client side, so that users on the client side are allowed to process local files conveniently using remote applications on the server side.

### SUMMARY OF THE INVENTION

The present invention provides an apparatus and method for processing local files using remote applications. The present invention further provides a method and a server for managing the remote applications.

An apparatus for processing local files using remote applications is provided, including: an operation capturing unit configured to capture user operations on local files, and send operation requests to the server; a file sharing unit configured to share the local files in the network and send the sharing path to the server; and a remote desktop unit configured to connect to the target processing appliance using remote desktop in response to the information of the target processing appliance associated with the remote application received from the server.

A remote application management server for managing the remote applications in the processing appliances is provided, the server including: a file type matching unit configured to match the local file to a particular remote application in response to the received file information of the local file in the client side; a processing appliance choosing unit configured to determine the target processing appliance associated with the particular remote application and send the information of the target processing appliance to the client; and an instruction file generating unit configured to generate the instruction file for the above processing appliances in response to the received file sharing path, wherein the instruction file contains the file sharing path.

A system for processing local files using remote applications is provided, including the apparatus according to the first aspect of the invention and the server according to the second aspect of the invention.

A method for processing local files using remote applications is provided, including: capturing user operations on local files and sending operation requests to the server; sharing the local files in the network and sending the sharing path to the server; and connecting to the target processing appliance using remote desktop in response to the information of the target processing appliance associated with the remote application received from the server.

A method of managing remote applications in the processing appliances is provided, including: matching the local file to a particular remote application in response to the received file information of the local file in the client side; determining the target processing appliance associated with the particular remote application and sending the information of the target processing appliance to the client; and generating the instruction file for the above processing appliances in response to the received file sharing path, wherein the instruction file contains the file sharing path.

With the remote processing solution in the present invention, a user can process local files simply by using remote applications without downloading and installing remote applications, or uploading the file to be processed to the server and downloading it to the local file, which makes the remote processing of local files more safe and convenient. Moreover, the remote processing system in this invention provides seamless processing experiences for users, which makes the remote processing easier to operate.

### BRIEF DESCRIPTION OF THE DRAWINGS

FIG. 1 illustrates a block diagram of an apparatus for processing local files using remote applications according to one embodiment of the invention.

FIG. 2 illustrates a block diagram of a server side of a system for remotely processing local files according to one embodiment of the invention.

FIG. 3 illustrates a block diagram of a remote application server according to one embodiment of the invention.

FIG. 4 illustrates a block diagram of a server side of a system for remotely processing local files according to another embodiment of the invention.

FIG. 5 illustrates a flowchart of a method for processing local files using remote applications according to one embodiment of the invention.

FIG. 6 illustrates a flowchart of a method for managing remote applications in processing appliances according to one embodiment of the invention.

FIG. 7 illustrates a sequence chart for starting a remote application in a system of processing local files using remote applications.

### DETAILED DESCRIPTION OF THE PREFERRED EMBODIMENTS

The following is a detailed description of the preferred embodiments of the invention in connection with the drawings.

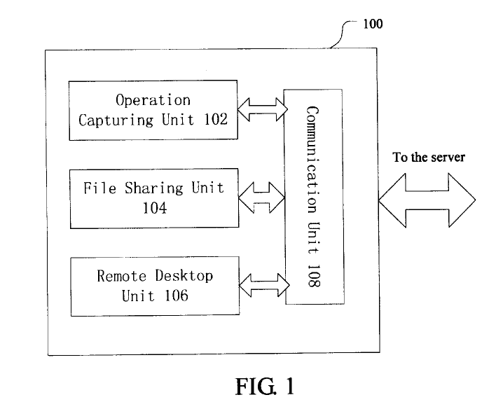

FIG. 1 illustrates a block diagram of an apparatus for processing local files using remote applications according to an embodiment of the invention. In FIG. 1, the apparatus is labeled using reference number 100 generally. Apparatus 100 is located on a client side to allow terminal users to process local files using remote applications. As shown in the figure, apparatus 100 includes an operation capturing unit 102, a file sharing unit 104, and a remote desktop unit 106.

Specifically, operation capturing unit 102 is configured to capture user operations on local files and send operation requests to a server side. The operations on local files include a processing request operation, such as double clicking a file icon, choosing ‘open’ a file in a right click menu, and other operations indicating users want to process the file, or a closing request operation, such as clicking ‘close’. Once users perform the above operations on local files, capturing unit 102 captures users' operation events and analyzes them to generate and send operation requests accordingly. When users make a processing request operation, operation capturing unit 102 will correspondingly generate a processing request and send it to the server. In case users make closing request operations, the operation capturing unit 102 will correspondingly generate closing requests.

In one embodiment, operation capturing unit 102 only captures operations related to remote processing. That is, if some proper desktop application for processing the file has been installed in users' local machine, users can use the local desktop application as a default to process the file. For this kind of operation, operation capturing unit 102 does not generate an operation request, therefore avoiding interruptions to users' ordinary operations. Alternatively, users can also choose using remote applications to process the file through particular operations. For example, apparatus 100 can add options like “use remote application to open” to the menu when users right click a file. When users choose this option, operation capturing unit 102 is activated to capture and analyze users' operations. For the files that there is no proper desktop application to process, operation capturing unit 102 can capture the operations on these files in default and generate corresponding operation request.

In one embodiment, operation capturing unit 102 further analyzes the captured operation events and extracts the related local file information. This information can include: the file name, the file type, and the file path. Based on extracting this information, operation capturing unit 102 encloses a part or all of this information in the processing request and sends it to the server. In accordance with this processing request, the server can judge whether there is proper remote application on the server side to process the local file referred in the request. If there is a plurality of proper remote applications for choosing on the server side, then operation capturing unit 102 can further capture users' choice of these remote applications and send the choosing information to the server.

Based on requesting the server to process the local file, it needs to share the local file in the network to allow the server access the local file. Therefore, file sharing unit 104 is configured to share the local file in the network and send the file sharing path to the server side. In one embodiment, after a proper remote application is chosen on the server side, a confirming message is returned to apparatus 100 to confirm that a remote application will be started to process the local file. Once receiving this confirming message, file sharing unit 104 starts sharing the local file. In another embodiment, apparatus 100 records on the client side the file type list that the server can process. By comparing this list and the file information captured by operation capturing unit 102, it can be determined whether the file to be processed can be processed remotely. When confirming the local file can be processed remotely, file sharing unit 104 then makes the file shared. There are various solutions for sharing files in the existing techniques, and file sharing unit 104 can use any existing sharing solution to share said local file in the network.

In one embodiment, file sharing unit 104 uses a NFS (network file system) to realize the file sharing. NFS is a disk file sharing method among UNIX systems and also a file system protocol, which supports applications on the client side accessing data in the server disk through a network. In NFS, the file to be shared is stored in the server of the system. To share the stored files, the server sends the file sharing path to the client, which makes the client side able to access the file through a network and therefore realizes file sharing. In this embodiment, file sharing unit 104 functions as the server in NFS and shares the local files to be processed by remote applications. Specifically, file sharing unit 104 provides the sharing path of the local file and sends the path to the server side corresponding to apparatus 100, that is, the remote application side used to process the local files. Thus, the remote application side acts as the client side in NFS, which can access the shared local file in the server (that is, file sharing unit 104) and further process it.

Other common file sharing solutions include systems such as Andrew File System (AFS), NetWare Core Protocol (NCP), and Common Internet File System (CIFS). For different operating systems and protocols, sometimes software like Samba is needed to connect them. It is understood that those skilled in the art can adopt any method (including but not limited to the above listed methods) based on the existing technologies to realize local file sharing according to one's needs.

Based on realizing file sharing and sending the file sharing path, the local file can be accessed by proper remote application. However, for users, they also hope to view the processing interface and control the remote processing. It is thus needed using remote desktop function to connect the client to the target processing appliance where the above remote application hosts, wherein the target processing appliance is designated by the server side according to the configuration of the managed processing appliances. After designating the target processing appliance, the server will send the information of the target processing appliance to apparatus 100.

Correspondingly, remote desktop unit 106 in apparatus 100 responds to the information of the target processing appliance associated with the remote application received from the server side and connects to the target processing appliance using remote desktop to provide the remote application interface in the processing appliance to users. Specifically, the target processing appliance information contains the physical address of the target processing appliance. After obtaining the address, remote desktop unit 106 can connect to the target processing appliance using a remote desktop function. Some existent operating systems have already provided remote desktop functions for users. There is special remote terminal software for realizing remote desktop functions such as Virtual Network Computing (VNC). Using these functions, remote desktop unit 106 can access the target processing appliance appointed by the server. It is understood that those skilled in the art can adopt any remote desktop approach to meet the use of apparatus 100 and unit 106 according to different operating systems and needs. Thus, using remote desktop functions, users on the client side can view the interface of processing local files by the remote application executed in the remote processing appliance and control the processing process. In addition, for users, the viewed process and interface using remote applications in the processing appliance on the server side to process local files are identical with those using desktop applications in the local machine. Therefore, the process using apparatus 100 to process local files remotely is entirely seamless for users.

When users finish processing local files using remote applications and hope to close the remote applications, as described above, operation capturing unit 102 can capture users' closing operation and send a closing request. In one embodiment, the closing request can contain the address of the target processing appliance in which the remote application runs in order to inform the server to close the target processing appliance. Once receiving the confirming information from the server that the target processing appliance has been closed, file sharing unit 104 stops sharing local files and remote desktop unit 106 disconnects the target processing appliance to end the remote processing process.

In one embodiment, apparatus 100 can further include a communication unit 108, which is configured to interact and communicate with the server side. The data sending and receiving between each unit in apparatus 100 and the server can all be executed via communication unit 108. Specifically, operation capturing unit 102 can send operation requests to the server via the communication unit 108; file sharing unit 104 can receive the confirming message from the server and send the sharing path to the server via the communication unit 108; and, remote desktop unit 106 can receive the information of target processing appliances via communication unit 108.

In apparatus 100, by using a file sharing approach, file sharing unit 104 enables the server to access and process local files, which allows users to process local files using remote applications without uploading local files to the server and downloading them to the local file after the finishing process, and therefore avoid troubles and security risks. The provision of remote desktop unit 106 allows users to use and control remote applications like using local desktop applications, which increases the maneuverability of apparatus 100.

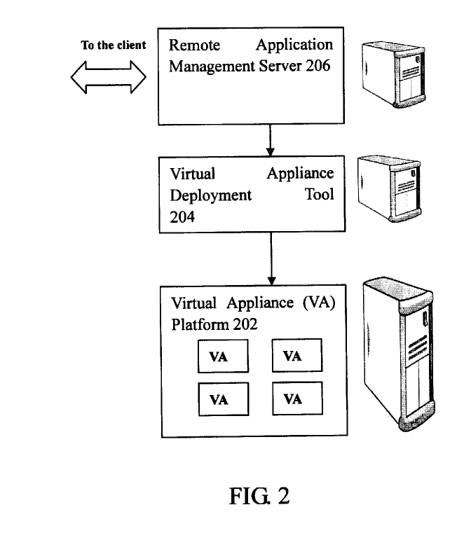

Corresponding with apparatus 100, to realize processing local files remotely, it is needed to accordingly manage the remote applications in processing appliances on the server side. FIG. 2 illustrates the block diagram of the server side of the system for remotely processing local files according to one embodiment of the invention. In the embodiment shown in FIG. 2, the remote processing of local files in the client side is executed in the virtual environment of the server side, that is, to deploy virtual appliances on the server side and use remote applications installed in the virtual appliances to process files in the client. As shown in FIG. 2, the server side includes a virtual appliance platform 202, a virtual appliance deployment tool 204 and a remote application management server 206.

Virtual appliance platform 202 is a hardware platform where virtual appliances reside. On this hardware platform, a plurality of virtual appliances (VA) can be provided, each of which runs in an independent environment. A plurality of desktop applications can be installed in each virtual appliance. These desktop applications are local desktop applications for the virtual appliance platform but are remote applications relative to apparatus 100 and the client side of the system. To avoid confusion, in this context, the desktop applications installed in virtual appliance platforms are still called remote applications. Although in FIG. 2 virtual appliance platform 202 is shown as a server platform, which provides a plurality of virtual appliances, it is understood that in other embodiments, virtual appliance platform 202 can include a plurality of sub-platforms in which a plurality of virtual appliances can be distributed as desired.

Virtual appliance deployment tool 204 is configured to automatically deploy and manage the virtual appliances in virtual appliance platform 202 according to deployment instructions. Virtual appliance deployment tool 204 can start up, shut down, configure, set and manage particular virtual appliances on particular hardware platforms designated in deployment instructions. In one embodiment, virtual appliance deployment tool 204 realizes direct deployment and management of virtual appliances using a Tivoli Provisioning Manager (TPM) server.

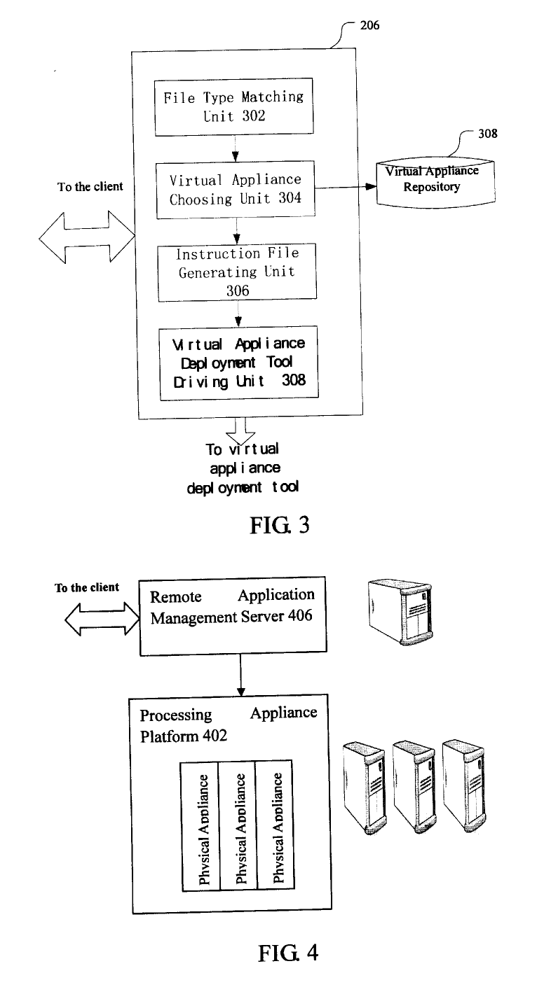

Remote application management server 206 connects to virtual appliance deployment tool 204 and directly communicates with apparatus 100 on the client side. It is configured to generate deployment instructions applicable for virtual appliance deployment tool 204 according to the request message from the client and realize management of remote applications in virtual appliance platform 202 via deployment tool 204. To achieve the above functions, the detailed structure of remote application management server 206 is shown as FIG. 3.

FIG. 3 illustrates the block diagram of remote application server according to one embodiment of the invention. As shown in FIG. 3, remote application management server 206 includes a file type matching unit 302 configured to respond to the received file information and match the file to a particular remote application; a virtual appliance choosing unit 304 which is configured to determine the target virtual appliance associated with the remote application and send the information of the target virtual appliance to the client; and an instruction file generating unit 306 which is configured to generate an instruction file for the virtual appliance in response to the received file sharing path.

In one embodiment, when remote application server 206 receives the processing request from the client, file type matching unit 302 first deals with the request. As described above, the processing request from the client contains the file information of the local files to be processed. The file information may contain the file name, the file type, and the file path. In the case that the file information contains the file type, file type matching unit 302 analyzes the file type and judges whether there is remote application matching with the type installed in virtual appliances. If it is determined that there is no matching remote application in virtual appliances, file type matching unit 302 then returns a negative message to the client and ends the processing. If there are multiple remote applications suitable for processing the files of this type, file type matching unit 302 can provide these remote applications to the client for users to choose. In another embodiment, file type matching unit 302 sets matching priority for a plurality of remote applications suitable for processing the files of one type, or sets a default application for each file type. Based on the priority setting or default setting, file type matching unit 302 can match or associate the file type contained in the processing request with a particular remote application. In the case that the above file information does not contain the file type directly, file type matching unit 302 is further configured to analyze and identify the file type to be processed according to other contained information. For example, file type matching unit 302 can recognize the file type according to the extended file name or the head information. After obtaining the file type to be processed, matching unit 302 matches the file type with a remote application according to the above method. Optionally, after determining the matching remote application, file type matching unit 302 can send a confirming message to the client to inform the client that the file can be processed by the remote applications on the server side.

Based on the determined remote application for processing the local file on the client, virtual appliance choosing unit 304 is configured to determine the target virtual appliance associated with the remote application, and send the information of the target virtual appliance to the client. Specifically, in one embodiment, virtual appliance choosing unit 304 determines the target virtual appliance via looking up in virtual appliance repository 308. Virtual appliance repository 308 is configured to store the information of each virtual appliance on virtual appliance platform 202 of FIG. 2. This information may include: the hosting hardware platform of each virtual appliance, the address of the hardware platform, the image file related to remote applications in each virtual appliance, the applications installed, the running status of each application, and the configuration status and running status of each virtual appliance. By querying this information, virtual appliance choosing unit 304 chooses the corresponding image file and virtual appliance according to the remote application determined by file type matching unit 302 and obtains the information of the virtual appliance, including the address thereof. Virtual appliance choosing unit 304 further sends the address of the determined virtual appliance to the client side to allow the client to connect to the target virtual appliance according to the address. Virtual appliance choosing unit 304 also provides the obtained virtual appliance information to instruction file generating unit 306.

Based on obtaining the file sharing path from the client and the above virtual appliance information, instruction file generating unit 306 generates the instruction file used for the above virtual appliance. The instruction file contains the file sharing path and the deployment information of the target virtual appliance to indicate the deployment and configuration to be achieved for the virtual appliance. Specifically, the instruction file is transferred to virtual appliance deployment tool 204, which is made to deploy the virtual appliances on virtual appliance platform 202 according to the information included in the instruction file. In one embodiment, the instruction file instructs virtual appliance deployment tool 204 to deploy and startup a particular virtual appliance and run a particular remote application therein, and further instructs the particular remote application to access and process the local files in the client side via the sharing path. When remote application management server 206 receives the closing request from the client, instruction file generating unit 306 extracts the virtual appliance address contained in the closing request and generates a new instruction file, which instructs virtual appliance deployment tool 204 to close the corresponding virtual appliance.

In one implementation, remote application management server 206 further includes a virtual appliance deployment tool driving unit 308, which is configured to encapsulate the instruction file into the format matching with the virtual appliance deployment tool and send it to the virtual appliance deployment tool. That is, driving unit 308 is configured to translate the instruction file into the deployment instructions, which can be directly accepted by virtual appliance deployment tool 204, thereby driving virtual appliance deployment tool 204 to deploy the virtual appliance according to the instructions.

Thus, remote application management server 206 can indirectly manage the remote applications in virtual appliances via virtual appliance deployment tool 204, which makes the remote applications on the server side to process local files on the client side according to operations from the client. Meanwhile, because remote application management server 206 can instruct virtual appliance deployment tool 204 to startup the needed virtual appliances and remote applications, and to close or sleep unnecessary virtual appliances according to needs, the utilization of virtual appliances makes the most use of the server resources and manages remote applications more flexibly. Moreover, remote application management server 206 is provided to deploy, configure and manage remote applications according to user operations, so that users on the client side can use the remote applications without downloading them to the local machine and installing the same, which further optimizes the remote processing process of local files.

In another implementation, a plurality of real processing appliances is provided on the server side to process local files in the client side that is to remotely process the local files in the conventional running environment of the server. The server in this implementation is shown in FIG. 4.

FIG. 4 illustrates a block diagram of the server side of the system for remotely processing local files according to another embodiment of the invention. As shown in FIG. 4, the server in this embodiment includes a processing appliance platform 402 and a remote application management server 406. Processing appliance platform 402 includes at least one physical processing appliance, in each of which a plurality of desktop applications are installed, hereafter still called remote applications. Remote application management server 406 connects to processing appliance platform 402 and instructs particular processing appliances to execute particular remote processing according to the request information from the client.

The structure and function of remote application management server 406 are similar to those of server 206 shown in FIG. 3. Specifically, server 406 includes a file type matching unit, a processing appliance choosing unit and an instruction generating unit, wherein the file type matching unit is configured to match the file type contained in the file information from the client with a particular remote application installed on processing appliance platform 402. The processing appliance choosing unit is configured to determine the target processing appliance associated with the remote application and send the information of the target processing appliance, including its address, to the client side. The instruction generating unit is configured to respond to the file sharing path received from the client to generate the instruction file for the physical processing appliance. The instruction file encloses the file sharing path in order to instruct particular physical processing appliance to access local files in the client side via the sharing path. Because the processing appliances in this embodiment are physical appliances, which need not to be deployed, it is thus unnecessary for the instruction file to contain the deployment information of the target appliance. Moreover, remote application management server 406 can connect to processing appliance platform 402 directly to issue instructions without the deployment tool. Therefore, the instruction file can be directly transferred to processing appliance platform 402 to instruct particular processing appliance therein to access and process local files remotely.

Joining client side apparatus 100 shown in FIG. 1 with the server side shown in FIG. 2 or FIG. 4, this invention can provide users with a complete system for processing local files using remote applications. With this system, users can use remote applications actually installed in virtual appliances on the server side to process local files like using local desktop applications.

Based on the same conception, this invention also provides the method for processing local files using remote applications and the method for managing remote applications in processing appliances.

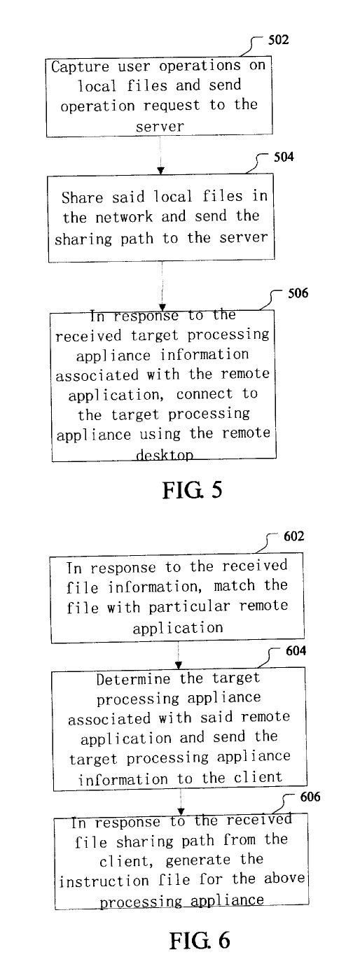

FIG. 5 illustrates the flowchart of the method for processing local files using remote applications according to one embodiment of the invention. The method is executed on the client side of the remote application system. As shown in FIG. 5, to realize processing local files remotely, first user operations on local files are captured and corresponding operation requests are sent to the server at step 502. Specifically, user operations can include processing request operation and closing operation, and therefore the operation requests can correspondingly include processing requests and closing requests. When users' processing request operations are captured, the local files directed by the operations are analyzed and the file information is extracted and contained in the processing requests. The file information can include: the file name, the file type, and the file path. In one embodiment, only the operations related to remote processing are captured at step 502.

Then the local files are shared in the network and the file sharing path is sent to the server side at step 504. In one embodiment, step 504 is executed in response to the confirming message from the server. The confirming message is the returned message when the server confirms it can process the local files using remote applications after checking and judgment. Once confirming the local files can be processed remotely, the method executes the step of sharing the local files. As described above, there are various file sharing solutions in existent techniques, like NFS, AFS, NCP, CIFS, etc. Based on these existent file sharing solutions, proper approaches can be adopted to realize the local files sharing according to needs at step 504.

In virtue of realizing file sharing and sending the sharing path, the local files can be accessed by proper remote applications. Thus at step 506, responding to the received target processing appliance information associated with the remote application from the server, the client connects to the target processing appliance via remote desktop, and thereby provides the interface of the remote application in the processing appliance to users. Specifically, the target processing appliance information contains the physical address of the target processing appliance. After obtaining the address, the client is able to connect to the target processing appliance using remote desktop function. The remote desktop function has already been provided for users in some existing operating systems and applications. Therefore, at step 506 the designated target processing appliance in the server side can be directly accessed using these functions. Then users on the client side can view the processing interface of the remote application running in the processing appliance on the server side and control the processing process.

Moreover, in the case that users perform closing operations, the closing request is sent to the server at step 502. In one embodiment, the closing request can contain the address of the target processing appliance hosting the remote application which processes the local files in order to notify the server to close the target appliance. In this embodiment, the above method also includes the following steps (not shown): responding to the confirming message from the server indicating the target processing appliance has been closed, stopping sharing of the local files, and disconnecting from the target processing appliance to end the remote processing process.

Corresponding to this method, to realize processing local files remotely, the method for managing remote applications in processing appliances is needed for the server side. FIG. 6 illustrates the flowchart of the method for managing the remote applications in the processing appliances according to one embodiment of the invention. As shown in FIG. 6, in response to the received file information, the method matches the file with a particular remote application at step 602. The above-mentioned file information may include the file name, the file type, and the file path, which are usually enclosed in the processing request sent from the client. Once receiving this file information, step 602 matches the proper remote application according to the information. Specifically, in case of being enclosed in the file information, the file type is directly analyzed and whether there is remote application matching with this type in the processing appliance is judged at step 602. In the case that it is not directly contained in the file information, at step 602, the file type to be processed needs to be firstly identified according to other information in the file information, for example, the extended file name, and the head information. After obtaining the file type to be processed, the method executes matching the file type with the remote application. Once determining the matching remote application, the server may send a confirming message to the client to inform the client that the file can be processed by the remote application on the server side.

Based on determining the remote application for processing the local file in the client, at step 604, the target processing appliance associated with the remote application is determined and the information of the target processing appliance is sent to the client. In one embodiment, the target processing appliance is determined by looking up a processing appliance repository. Specifically, based on the remote application determined at step 602, step 604 looks up the processing appliance repository and chooses the proper processing appliance and image file corresponding to the remote application, and obtains the information of the processing appliance, including its address. It further sends the determined processing appliance address to the client side to enable the client to connect with the target processing appliance according to the address.

To finally manage the processing appliance and the corresponding remote application, at step 606, the instruction file used for the above processing appliance is generated in response to the received file sharing path from the client. In the case that the processing appliance is physical appliance, the instruction file contains the above file sharing path in order to instruct particular physical appliance to access and process the local files according to the path. In the case that the processing appliance is a virtual appliance, the instruction file further contains the target virtual appliance information in order to indicate the deployment of the target virtual appliance. In one embodiment, the instruction file can instruct the virtual appliance deployment tool to deploy and startup a particular virtual appliance and run a particular remote application therein, and further instruct the remote application to access and process the local files in the client side using the sharing path.

When the client requests ending the processing process by sending a closing request, the above method further includes the following steps of (not shown): extracting the contained processing appliance address from the closing request, and thereby generating a new instruction file which instructs the virtual appliance deployment tool to close the corresponding virtual appliance.

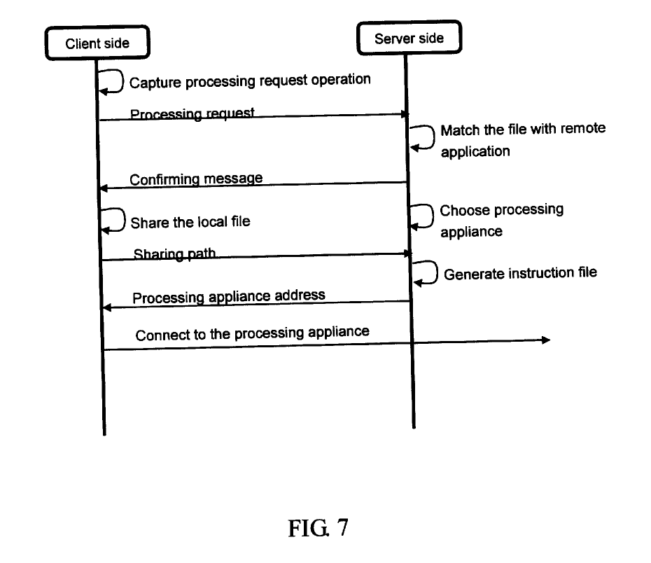

FIG. 7 illustrates the sequence chart of starting the remote applications in the system of processing local files using remote applications. The sequence is used to illustrate the processing steps between the client and the server in the case that the processing appliance on the server side is a virtual appliance. For the case that the processing appliance is a physical appliance, the steps are similar to those shown in FIG. 6. In FIG. 7, the steps on the left are executed on the client side and the steps on the right are executed on the server side. As shown in the figure, first a processing request operation of a user on a local file is captured on the client side, and therefore the client sends the corresponding processing request to the server. After receiving the processing request, the server matches the local file in the client side referred in the processing request with a particular remote application in virtual appliances on the server side and sends the confirming message to the client. The client then shares the local file in response to the confirming message, and sends the sharing path to the server. On the other hand, the server can choose the corresponding virtual appliance based on the matching remote application and contain the sharing path in the instruction file for the virtual appliance in order to indicate the deployment and configuration to be achieved of the virtual appliance. The server further sends the address of the virtual appliance to the client to enable the client to connect with the virtual appliance according to the address. Through the above description, it can be seen that the client and server communicate continually, exchanging information and triggering the steps of remote processing. Using the above process, the remote application in the virtual appliance on the server side is activated under the triggering of the processing request from the client, and starts to process the local file on the client side.

It is understood that in FIG. 7 the steps executed on the client side are corresponding to the method in FIG. 5, the steps executed on the server side are corresponding to the method in FIG. 6, and the method in FIG. 5 can be executed by apparatus 100 in FIG. 1, the method in FIG. 6 can be executed by server 206 in FIG. 3.

Through the above description of the embodiments, those skilled in the art will recognize that the above-mentioned method and apparatus can be practiced by executable instructions and/or controlling codes in the processors, for example, codes provided in mediums like disc, CD or DVD-ROM; memories like ROM or EPROM; and carriers like optical or electronic signal carrier. The apparatus and its modules in above embodiments can be realized using hardware like VLSI or Gates and Arrays, like semiconductors, for example, Logic Chip, transistors, or similar programmable hardware equipments, such as FPGA and programmable logic equipment, or using software executed by different kinds of processors, or using the integration of the hardware and software.

The above-described exemplary embodiments are intended to be illustrative in all respects of the method and apparatus for processing local files using remote applications, rather than restrictive, of the present invention. Those skilled in the art should recognize that the present invention is capable of many variations and modifications within the scope and spirit of the present invention. The scope of the present invention is defined only by the appended claims.

What is claimed is:

1. An apparatus for processing local files using remote applications, comprising:
an operation capturing unit to capture user operations on local files and send operation requests to a server;
a file sharing unit to share said local files in a network and send a sharing path to the server; and
a remote desktop unit to connect to the target processing appliance using remote desktop in response to information of a target processing appliance associated with remote application received from the server.

2. The apparatus of claim 1, wherein said operation capturing unit extracts file information of said local files, the file information comprising at least one of a file name, a file path and a file type.

3. The apparatus of claim 1, wherein:
said operation requests include a closing request, which contains information of the target processing appliance;
said file sharing unit stops sharing said local files in response to a notice of closing the target processing appliance from the server; and
said remote desktop unit disconnects with said target processing appliance in response to said notice.

4. The apparatus of claim 1, wherein said file sharing unit realizes file sharing using at least one of a Network File System (NFS), Andrew File System (AFS), or Common Internet File System (CIFS).

5. A remote application management server for managing remote applications in processing appliances, comprising:
a file type matching unit match a local file to a particular remote application in response to received file information of the local file on client side;
a processing appliance choosing unit to determine a target processing appliance associated with said particular remote application and send the information of the target processing appliance to a client; and
an instruction file generating unit to generate an instruction file for the processing appliances in response to a received file sharing path, wherein the instruction file contains said file sharing path.

6. The server of claim 5, wherein said file type matching unit identifies the file type according to said file information.

7. The server of claim 5, wherein said processing appliance choosing unit determines the target processing appliance associated with said particular remote application by looking up stored information in a processing appliance repository.

8. The server of claim 7, wherein said stored information includes: an address of each processing appliance and remote applications installed in each processing appliance of at least one processing appliance.

9. The server of claim 5, wherein said processing appliance is virtual appliance.

10. The server of claim 9, wherein said instruction file further comprises: deployment information of a target virtual appliance.

11. The server of claim 9, further comprising a virtual appliance deployment tool driving unit to encapsulate said instruction file into a format matching with the virtual appliance deployment tool and send it to said virtual appliance deployment tool.

12. A system for processing local files using remote applications, comprising the server of claim 5 and an apparatus for processing local files using remote applications comprising:
an operation capturing unit to capture user operations on local files and send operation requests to a server;
a file sharing unit to share said local files in a network and send a sharing path to the server; and
a remote desktop unit to connect to the target processing appliance using remote desktop in response to information of a target processing appliance associated with remote application received from the server.

13. A method for processing local files using remote applications, comprising the steps of:
capturing user operations on local files and sending operation requests to a server;
sharing said local files in a network and sending a sharing path to the server; and
connecting to a target processing appliance using a remote desktop in response to information of the target processing appliance associated with the remote application received from the server.

14. The method of claim 13, further comprising extracting file information of said local files, the file information comprising at least one of a file name, a file path and a file type.

15. The method of claim 13, further comprising: stopping sharing said local files, and disconnecting with said target processing appliance in response to a notice of closing the target processing appliance from the server.

16. The method of claim 13, wherein the step of sharing said local files in the network comprises: realizing file sharing using at least one of a Network File System (NFS), Andrew File System (AFS), or Common Internet File System (CIFS).

17. A method for managing remote applications in processing appliances, comprising the steps of:
matching a local file to a particular remote application in response to a received file information of a local file on client side;
determining a target processing appliance associated with said particular remote application and sending information of the target processing appliance to client; and
generating an instruction file for the above processing appliances in response to a received file sharing path, wherein the instruction file contains a file sharing path.

18. The method of claim 17, further comprising:
identifying file type according to said file information.

19. The method of claim 17, wherein the step of determining the target processing appliance comprises:
determining the target processing appliance associated with said particular remote application by looking up stored information in a processing appliance repository.

20. The method of claim 19, wherein said stored information comprises: an address of each processing appliance and the remote applications installed in each processing appliance of at least one processing appliance.

21. The method of claim 17, wherein said processing appliance is a virtual appliance.

22. The method of claim 21, wherein said instruction file further comprises deployment information of the target virtual appliance.

23. The method of claim 21, further comprising:
encapsulating said instruction file into a format matching with the virtual appliance deployment tool and sending it to said virtual appliance deployment tool.
